(19) United States
(12) Patent Application Publication
(10) Pub. No.: US 2011/0058579 A1
(43) Pub. Date: Mar. 10, 2011

(54) LASER LIGHT SOURCE

(76) Inventors: Yoshiyuki Ohtake, Shizuoka (JP); Haruyasu Ito, Shizuoka (JP); Taro Ando, Shizuoka (JP); Takashi Inoue, Shizuoka (JP); Naoya Matsumoto, Shizuoka (JP); Norihiro Fukuchi, Shizuoka (JP)

(21) Appl. No.: 12/991,271

(22) PCT Filed: May 21, 2009
(86) PCT No.: PCT/JP2009/059348

§ 371 Date: Nov. 5, 2010

(30) Foreign Application Priority Data
May 29, 2008 (JP) 2008-141177

(51) Int. Cl. H01S 3/139

(52) U.S. Cl. 372/19

(57) ABSTRACT

A laser light source 1 is provided with an output mirror 11, a laser medium 12, a light beam diameter adjuster 13, an aperture 14, a reflection mirror 15, a drive unit 21, and a control unit 22, and outputs laser oscillation light 31 from the output mirror 11 to the outside. The laser resonator is configured so that the reflection mirror 15 and the output mirror 11 are disposed so as to be opposed to each other with the laser medium 12 placed therebetween. The reflection mirror 15 is configured such that it gives amplitude or phase variations to respective positions in the section of a light beam when the light is reflected, and the reflection mirror presents a amplitude or phase variation distribution in accordance with control from the outside, and determines the transverse mode of the laser oscillation light 31 based on the amplitude or phase variation distribution. Thus, a laser light source capable of easily controlling the transverse mode of the laser oscillation light can be realized.

### TECHNICAL FIELD

The present invention relates to a laser light source.

### BACKGROUND ART

In a laser light source provided with a laser resonator configured so that a reflection mirror and an output mirror are disposed so as to be opposed to each other with a laser medium placed therebetween, stimulated emission light emitted from an excited laser medium is reflected by the reflection mirror, while a part of the stimulated emission light passes through the output mirror and the remaining part thereof is reflected therefrom. Laser oscillation is produced by reciprocation of the stimulated emission light between the reflection mirror and the output mirror. Laser oscillation light which passes through the output mirror and is output to the outside generally becomes such that some transverse modes are overlapped thereon.

However, in accordance with usage, there are cases where it is required that the laser oscillation light output from the laser light source is subjected to only the fundamental mode as the transverse mode, or, there are cases where it is required that the laser oscillation light is subjected to only another specific transverse mode.

The invention disclosed in Patent Document 1 intends that the laser oscillation light of a specific transverse mode is selectively output from a laser resonator. The laser light source disclosed in this document is provided with a discontinuous phase element on the resonance light path in the laser resonator. The discontinuous phase element gives phase variations to respective positions in the section of a light beam for the stimulated emission light reciprocating in the laser resonator. The discontinuous phase element has a thickness distribution and gives a phase variation distribution corresponding to the thickness distribution to the stimulated emission light, wherein the transverse mode of the laser oscillation light is determined.

Citation List

Patent Literature

Patent Document 1: Japanese Translation of PCT International

Application (Kohyo) No. 2001-523396

### SUMMARY OF THE INVENTION

Technical Problem

However, since, in the laser light source disclosed in Patent Document 1, the phase variation distribution given to the stimulated emission light by the discontinuous phase element is fixed, dynamic control of the transverse mode of the laser oscillation light is impossible. Therefore, since the phase variation distribution given to the stimulated emission light cannot be adjusted, there are cases where the laser oscillation light of a specific transverse mode cannot be efficiently obtained. Further, although it is necessary to replace a discontinuous phase element, which is inserted into the laser resonator, in order to change the transverse mode of the laser oscillation light, generally it is not easy to replace the same because fine optical re-adjustment is required with replacement of the element.

The present invention has been developed in order to solve the above-described problems, and it is therefore an object of the invention to provide a laser light source which is capable of easily controlling the transverse mode of laser oscillation light.

Solution to Problem

A laser light source according to the present invention is provided with a laser resonator in which a reflection mirror and an output mirror are disposed so as to be opposed to each other with a laser medium placed therebetween. Further, the reflection mirror is configured such that it gives amplitude or phase variations to respective positions in the section of a light beam when the light is reflected, the reflection mirror presents an amplitude or phase variation distribution in accordance with control from the outside, and determines a transverse mode of laser oscillation light based on the amplitude or phase variation distribution. With the laser light source according to the invention, since the amplitude or phase variation distribution is presented in the reflection mirror, the transverse mode of the stimulated emission light efficiently generated in the laser resonator of the laser light source is determined, and the laser oscillation light of the transverse mode is output from the output mirror to the outside.

Advantageous Effects of Invention

The laser light source according to the present invention can easily control the transverse mode of laser oscillation light.

### BRIEF DESCRIPTION OF DRAWINGS

FIG. 1 is a configuration diagram of a laser light source 1 according to a first embodiment.

FIG. 2 is a diagram showing examples of a phase variation distribution presented in a reflection mirror 15 included in the laser light source 1 according to the first embodiment.

FIG. 3 is a diagram showing an example of a phase variation distribution in a loss region of the phase variation distribution presented in the reflection mirror 15 included in the laser light source 1 according to the first embodiment.

FIG. 4 is a diagram showing other examples of the phase variation distribution in the loss region of the phase variation distribution presented in the reflection mirror 15 included in the laser light source 1 according to the first embodiment.

FIG. 5 is a diagram showing other examples of the phase variation distribution presented in the reflection mirror 15 included in the laser light source 1 according to the first embodiment.

FIG. 6 is a diagram showing examples of a light intensity profile of laser oscillation light 31 output from the laser light source 1 according to the first embodiment.

FIG. 7 is a configuration diagram of a laser light source 2 according to a second embodiment.

FIG. 8 is a diagram showing examples of a phase variation distribution presented in a reflection mirror 15 included in the laser light source 2 according to the second embodiment.

### DESCRIPTION OF THE EMBODIMENTS

Hereinafter, a detailed description is given of embodiments for carrying out the present invention with reference to the accompanying drawings. The same elements will be denoted by the same reference symbols in the description of the drawings, and overlapping description thereof will be omitted.

### First embodiment

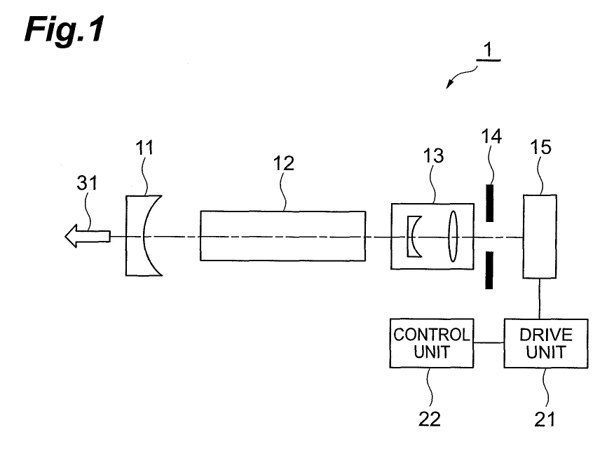

FIG. 1 is a configuration diagram of a laser light source 1 according to a first embodiment. The laser light source 1 shown in this figure is provided with an output mirror 11, a laser medium 12, a light beam diameter adjuster 13, an aperture 14, a reflection mirror 15, a drive unit 21 and a control unit 22, and outputs laser oscillation light 31 from the output mirror 11 to the outside.

The reflection mirror 15 and the output mirror 11 are disposed so as to be opposed to each other with the laser medium 12 placed therebetween, and thereby a laser resonator is configured. The laser medium 12 is excited to an upper energy level by supply of excitation energy, and emits light at the time of transition from the upper energy level to a lower energy level. The laser medium 12 may be a gas such as Ar gas, He-Ne gas, CO₂ gas, etc., or may be a liquid such as an organic solvent containing a dye molecule, etc., or may be a solid substance such as Nd:YAG, etc., or further may be a laser diode.

The output mirror 11 transmits a part of incident light to the outside and reflects the remaining part thereof. It is preferable that, in order to efficiently produce the laser oscillation, the reflection surface of the output mirror 11 is made into a concave surface having a specific curvature (for example, 15m).

It is required that the reflection mirror 15 has a high reflectance at the wavelength of the laser oscillation light 31. The reflection mirror 15 is configured such that it gives amplitude or phase variations responsive to respective positions in the section of a light beam when the light is reflected, the reflection mirror presents an amplitude or phase variation distribution in accordance with control from the outside, and determines the transverse mode of the laser oscillation light 31 based on the amplitude or phase variation distribution.

The reflection mirror 15 may be a spatial light modulator (hereinafter called “SLM”) which spatially modulates the amplitude or the phase of the incident light and reflects the incident light, or may be a segment type deformable mirror or a MEMS element which spatially modulates the phase of the incident light and reflects the incident light. Also, it is preferable that the reflection mirror 15 is an LCOS (Liquid Crystal on Silicon) type SLM among the SLMs.

The LCOS type SLM has features which are a high reflectance, a high phase modulation rate, and a small size, and spatially modulates the phase of the incident light and reflects the incident light. In addition, it is preferable that the reflection surface of the reflection mirror 15 is coated for reflection so that a high reflectance is brought about in the wavelength of the laser oscillation light 31, wherein it is possible that a reflectance of about 90% is secured. Further, in the following, a description of embodiments is mainly based on that the reflection mirror 15 is an LCOS type SLM.

The drive unit 21 is connected to the reflection mirror 15 and is also connected to the control unit 22. The control unit 22 is, for example, a personal computer, and drives the reflection mirror 15 via the drive unit 21. In the case where the reflection mirror 15 is an LCOS type SLM, the control unit 22 sets the phase variation amounts when carrying out reflection at respective positions on the reflection surface of the reflection mirror 15, and drives the reflection mirror 15 via the drive unit 21, thereby the set phase variation distribution is presented in the reflection mirror 15.

It is preferable that the light beam diameter adjuster 13 is provided on the resonance light path in the laser resonator. The light beam diameter adjuster 13 adjusts the beam diameter of light incident on the reflection mirror 15, and for example, the adjuster is composed to include two lenses and is installed on the light path between the laser medium 12 and the reflection mirror 15. In the light beam diameter adjuster 13, the light beam diameter in the light path between the light beam diameter adjuster 13 and the reflection mirror 15 is increased in comparison with the light beam diameter in the light path between the laser medium 12 and the light beam diameter adjuster 13. By the light beam diameter adjuster 13 being provided, it is possible to make the light incident into a region where the phase can be modulated on the reflection mirror 15, and the region where the phase can be modulated can be effectively used. Also, if the resolution of the reflection mirror 15 is sufficient in view of generating a desired transverse mode, the light beam diameter adjuster 13 is not required.

In addition, it is preferable that the aperture 14 is provided on the resonance light path in the laser resonator. The aperture 14 restricts the beam diameter of the light incident on the reflection mirror 15, and is provided, for example, on the light path between the light beam diameter adjuster 13 and the reflection mirror 15. The aperture 14 prevents generation of unintended and unnecessary transverse mode light from occurring. In addition, in the case where it is not necessary to prevent generation of unintended transverse mode light from occurring, the aperture 14 is not required.

The laser light source 1 operates as follows. When excitation energy is supplied to the laser medium 12, the laser medium 12 is excited to an upper energy level, and light is emitted from the laser medium 12 at the time of transition from the upper energy level to the lower energy level. While the light emitted from the laser medium 12 is reflected from the reflection mirror 15, a part thereof is transmitted through the output mirror 11 and the remaining part thereof is reflected. By the light reciprocating between the reflection mirror 15 and the output mirror 11, the light interacts with the laser medium 12, and the stimulated emission light is generated by the laser medium 12, thereby producing the laser oscillation.

Further, the beam diameter of the light directed from the laser medium 12 to the reflection mirror 15 in the laser resonator is enlarged by the light beam diameter adjuster 13, and the beam diameter thereof is restricted by the aperture 14. The reflection mirror 15 is driven by the drive unit 21 controlled by the control unit 22, and presents an amplitude or phase variation distribution. Then, when the light incident into the reflection mirror 15 is reflected by the reflection mirror 15, the amplitude or phase variations, which are responsive to the respective positions in the section of the light beam, are given to the reflected light. Further, in the case where the reflection mirror 15 is an LCOS type SLM, phase variations responsive to the respective positions in the section of the light beam are given to the reflected light. Then, the transverse mode of the laser oscillation light 31 is determined based on the variation distribution.

It is preferable that the reflection mirror 15 presents the amplitude or phase variation distribution to cause the Laguerre-Gauss mode light (hereinafter called “LG mode light”) to be subjected to laser oscillation, and it is also preferable that the reflection mirror presents the amplitude or phase variation distribution to cause the Hermite-Gauss mode light (hereinafter called “HG mode light”) to be subjected to laser oscillation. The LG mode and the HG mode, respectively, are representative examples of the transverse mode which is an electric field amplitude pattern of light on the section of the light beam perpendicular to the light traveling direction.

The LG mode is a transverse mode of laser oscillation light, which can be frequently observed in the case where the sectional shape of the laser medium 12 is circular, and is specified by a radial index p and an angular index k. Hereinafter, the LG mode in which the radial index is p and the angular index is k is expressed to be LG(p,k). On the other hand, the HG mode is a transverse mode of laser oscillation light which can be frequently observed in the case where the sectional shape of the laser medium 12 is rectangular, and is specified by two indexes n and m. Hereinafter, the HG mode of the indexes n and m is expressed to be HG(n,m).

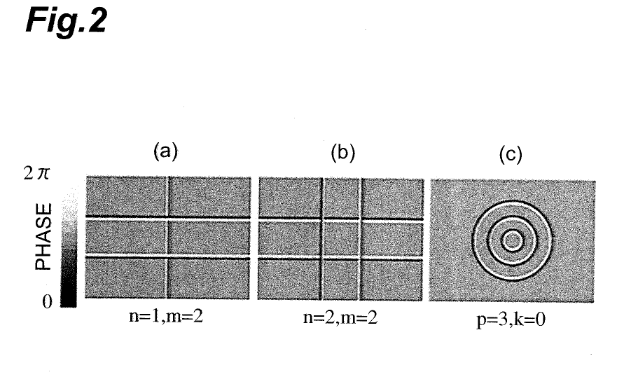

FIG. 2 is a diagram showing examples of the phase variation distribution presented to the reflection mirror 15 included in the laser light source 1 according to the first embodiment. (a) to (c) in FIG. 2, respectively, show the magnitude (0 to 2π) of the phase variation at respective positions on the reflection surface of the reflection mirror 15, using a contrasting density.

(a) and (b) in FIG. 2 show the phase variation distributions, which are presented in the reflection mirror 15 to cause the HG mode light to be subjected to laser oscillation. FIG. 2(a) shows the phase variation distribution, which causes the HG(1,2) mode light to be subjected to laser oscillation, and FIG. 2(b) shows the phase variation distribution, which causes the HG(2,2) mode light to be subjected to laser oscillation.

(c) in FIG. 2 shows the phase variation distribution, which is presented in the reflection mirror 15 to cause the LG mode light to be subjected to laser oscillation. FIG. 2(c) shows the phase variation distribution, which causes the LG(3,0) mode light to be subjected to laser oscillation.

The phase variation distribution presented in the reflection mirror 15 for the HG mode light is different from the phase variation distribution for the LG mode light. Even in the case of the HG mode light, if the index n or the index m differs, the phase variation distribution presented in the reflection mirror 15 differs. In addition, even in the case of the LG mode light, if the radial index p or the angular index k differs, the phase variation distribution presented in the reflection mirror 15 differs.

However, in any of the HG(n,m) mode light and the LG(p,k) mode light, it is common in that, regardless of the indexes, a phase variation distribution, which gives a loss to the light, is used in a predetermined region including a node in which the light intensity becomes zero in the transverse mode to be subjected to oscillation (hereinafter called a “loss region”), and further, a phase variation distribution, by which light is reflected at a high reflectance, is used in a region other than the above-described loss region (hereinafter called a “reflection region”).

Giving a loss to light in the loss region means lowering of light intensity in a region corresponding to the loss region on the beam section of light reflected by the reflection mirror 15 and incident into the laser medium 12. In detail, this includes absorption of light incident into the loss region, scattering of light incident into the loss region, and reflection or diffraction of light incident into the loss region in the direction not contributing to stimulated emission in the laser medium 12.

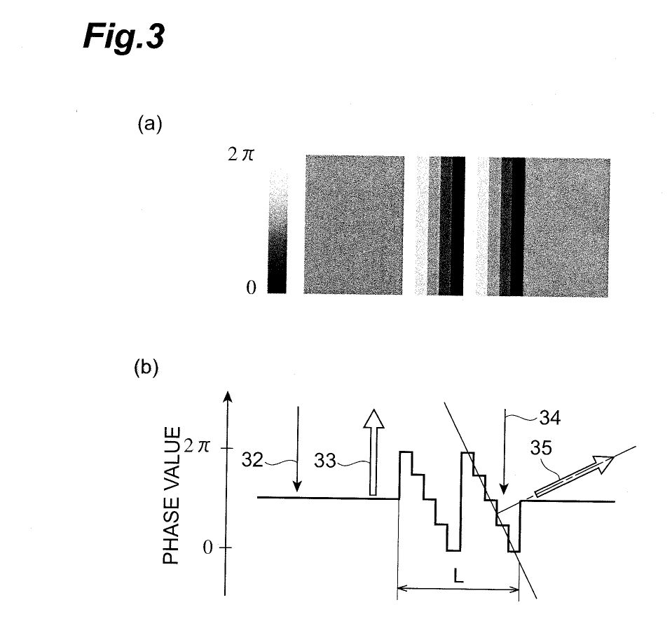

FIG. 3 is a diagram showing an example of a phase variation distribution in the loss region of the phase variation distribution presented to the reflection mirror 15 included in the laser light source 1 according to the first embodiment. (a) in FIG. 3 shows the magnitude (0 to 2π) of the phase variation at respective positions in a certain range including the loss region, using a contrasting density. Further, (b) in FIG. 3 shows the phase variation distribution with the horizontal axis used for the position and the vertical axis used for the phase variation. In FIG. 3(b), a region of width L is the loss region, and the region other than the loss region is the reflection region.

As shown in FIG. 3, since the phase variation at respective positions in the reflection region is a fixed value (for example, π), the light 32 incident into the reflection region is almost regularly reflected, and the reflected light 33 is made incident into the laser medium 12. On the other hand, since the phase variation at respective positions in the loss region changes stepwise in one direction, the light 34 incident into the loss region is reflected in a direction differing from the regular reflection direction, and the reflected light 35 is not made incident into the laser medium 12.

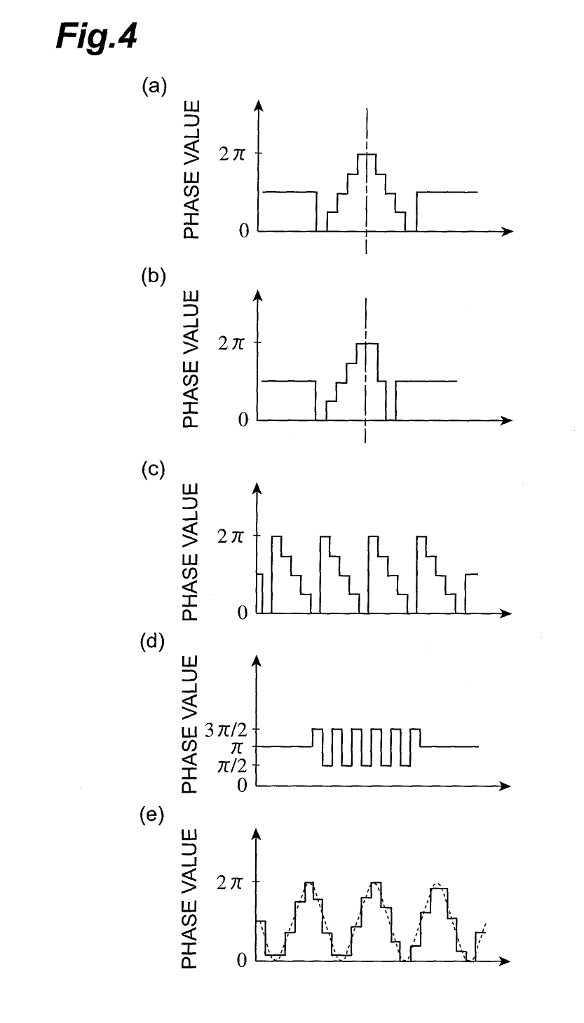

FIG. 4 is a diagram showing other examples of the phase variation distribution in the loss region of the phase variation distribution presented in the reflection mirror 15 included in the laser light source 1 according to the first embodiment. (a) to (e) in FIG. 4, respectively, show the phase variation distributions with the horizontal axis used for the position and the vertical axis used for the phase variation.

In the phase variation distributions in the loss region shown in (a) and (b) in FIG. 4, respectively, the phase variation changes stepwise in both directions, and the incident light is reflected in two directions differing from the regular reflection direction. In the phase variation distribution in the loss region shown in FIG. 4(a), the light is reflected in two directions which are symmetrical to each other. Further, in the phase variation distribution in the loss region shown in FIG. 4(b), the light is reflected in two directions which are asymmetrical to each other.

The phase variation distribution in the loss region shown in (c) in FIG. 4 is such that the change repetition period in the phase variation distribution shown in (b) in FIG. 3 is shortened, and at the same time, the number of times of change repetition is increased. This is a phase distribution referred to as a blazed diffraction grating, and diffracts the incident light in a direction differing from the regular reflection direction. The change repetition period in the phase variation distribution shown in (a) or (b) in FIG. 4 may be shortened, and the number of times of change repetition therein may be increased, and thereby the phase distribution of the blazed diffraction grating may be brought about.

In the phase variation distributions in the loss region shown in (d) and (e) in FIG. 4, respectively, the phase variation at respective positions periodically changes, and the distribution is a periodic phase distribution, which has a function equivalent to the reflection type diffraction grating. In the phase variation distribution in the loss region shown in FIG. 4(d), the phase variations of respective pixels become any one of two values. Further, in the phase variation distribution in the loss region shown in FIG. 4(e), the phase variations of respective pixels are made into values approximate to values of a sine function (dashed line in the figure) using the position as a variable. These diffract the incident light in a direction differing from the regular reflection direction.

Further, in the case where the reflection mirror 15 is an LCOS type SLM, the reflection mirror 15 can present only the phase variation distribution. Thus, in the case where the reflection mirror 15 can present only the phase variation distribution, it is preferable that, when the phase variation distribution in the loss region is Fourrier-transformed in terms of the spatial frequency, the component of spatial frequency 0 included in the Fourier transform result is 50% or less. In addition, in the case where the reflection mirror 15 can present only the amplitude variation distribution, it is preferable that the reflectance in the loss region is 50% or less with respect to the reflectance in the reflection region. Furthermore, in the case where the reflection mirror 15 can present both the amplitude variation distribution and the phase variation distribution, it is preferable that the reflectance to the regular reflection direction in the loss region is 50% or less with respect to the reflectance in the reflection region.

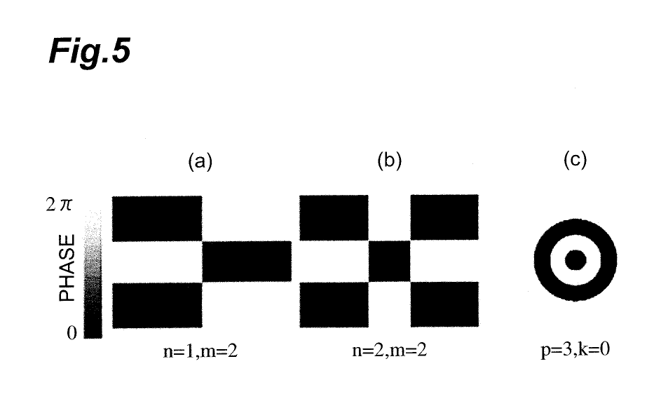

FIG. 5 is a diagram showing other examples of the phase variation distribution presented in the reflection mirror 15 included in the laser light source 1 according to the first embodiment. (a) in FIG. 5 shows the phase variation distribution, which causes the HG(1,2) mode light to be subjected to laser oscillation, (b) in FIG. 5 shows the phase variation distribution, which causes the HG(2,2) mode light to be subjected to laser oscillation, and (c) in FIG. 5 shows the phase variation distribution, which causes the LG(3,0) mode light to be subjected to laser oscillation.

In the examples shown in (a) to (c) in FIG. 5, respectively, the magnitude of the phase variation at respective positions on the reflection surface of the reflection mirror 15 is 0 or 2π. The respective regions in which the phase variation is 0 or 2πare shown with black regions and white regions. In the case where the LCOS type SLM is used as the reflection mirror 15, since the SLM has a pixel structure and has definite resolution, a narrow and steep phase variation distribution is formed at the boundary between two regions the phase variations of which are different by 2π from each other, thereby effects similar to those of the above—described loss region can be brought about.

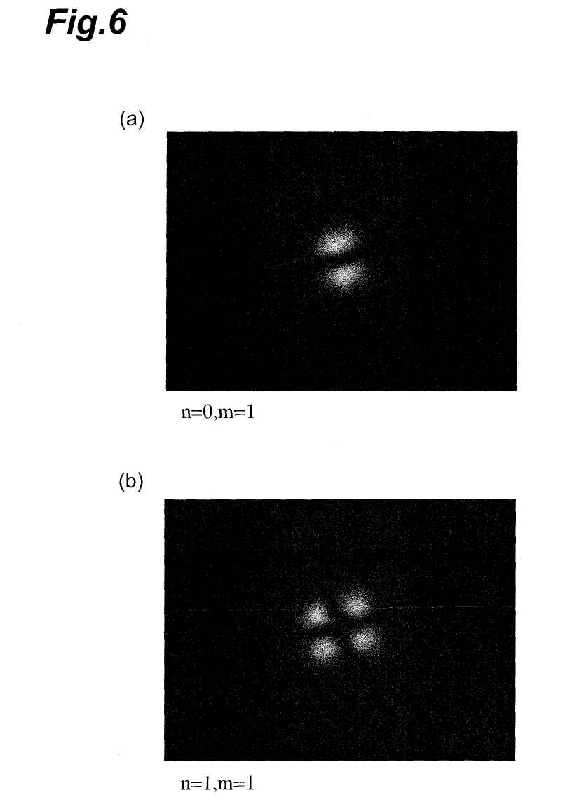

FIG. 6 is a diagram showing examples of a light intensity profile of the laser oscillation light 31 output from the laser light source 1 according to the first embodiment. (a) in FIG. 6 shows an example of the light intensity profile of the HG(0,1) mode light, and (b) in FIG. 6 shows an example of the light intensity profile of the HG(1,1) mode light. Thus, the laser oscillation light 31 of a specific transverse mode can be obtained.

As described above, in the present embodiment, by presenting the amplitude or phase variation distribution in the reflection mirror 15, the transverse mode of the stimulated emission light generated in the laser resonator of the laser light source 1 is efficiently selected, and the laser oscillation light 31 having the transverse mode is output from the output mirror 11 to the outside. In the present embodiment, the reflection mirror 15 is driven by the drive unit 21 controlled by the control unit 22, and the amplitude or phase variation distribution is presented in the reflection mirror, and therefore, it is possible to easily obtain the laser oscillation light 31 having a desired transverse mode.

In addition, since the node portion in which the light intensity becomes zero in the transverse mode can be appropriately set in accordance with the beam diameter of the laser oscillation light 31 and the beam shape thereof, it is possible to efficiently obtain the laser oscillation light 31 of a specified transverse mode.

Further, in the present embodiment, it is preferable that, in addition to the amplitude or phase variation distribution for determining the transverse mode of the laser oscillation light 31, the reflection mirror 15 overlaps and presents the phase variation distribution, which compensates for the phase distortion resulting from the optical elements (laser medium 12 and light beam diameter adjuster 13) in the laser resonator, and it is also preferable that the reflection mirror overlaps and presents the phase variation distribution which operates as a concave mirror, and further, it is also preferable that, in the case where the reflection surface of the reflection mirror 15 is inclined with respect to the plane perpendicular to the optical axis of the laser resonator, the reflection mirror overlaps and presents the phase variation distribution to compensate for the inclination. In such cases, since the reflection mirror 15 is driven by the drive unit 21 controlled by the control unit 22 and the phase variation distribution is presented in the reflection mirror, it is possible to efficiently obtain the laser oscillation light 31 of a specified transverse mode.

In addition, in the present embodiment, in order to efficiently obtain laser oscillation light 31 of a specified transverse mode, it is possible to feedback control the amplitude or phase variation distribution, which is presented in the reflection mirror 15, via the drive unit 21 by the control unit 22 based on the light intensity profile obtained by monitoring the light intensity profile of the laser oscillation light 31.

### Second embodiment

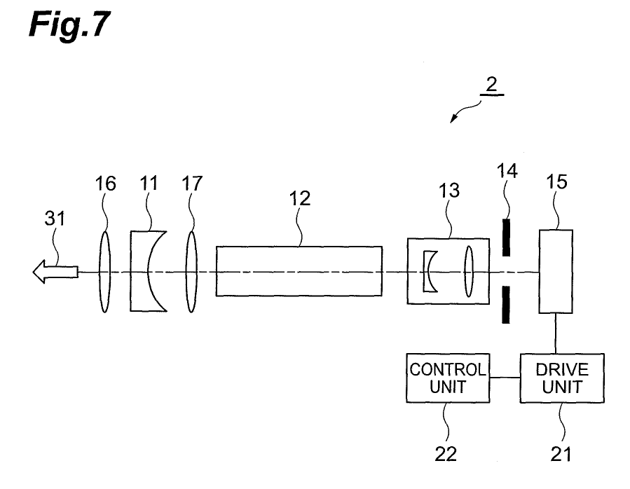

FIG. 7 is a configuration diagram of a laser light source 2 according to a second embodiment. The laser light source 2 of the second embodiment shown in this figure is further provided with a cylindrical lens 16 and a cylindrical lens 17 in addition to the configuration of the laser light source 1 of the first embodiment shown in FIG. 1. The laser light source 2 has a favorable configuration for outputting LG mode light, the angular index k of which is not zero, (that is, LG mode light having a spiral structure of phase in the section of the light beam) as the laser oscillation light 31.

The cylindrical lens 16 and the cylindrical lens 17 are disposed with the output mirror 11 placed therebetween. The focal lines of the cylindrical lens 16 and the cylindrical lens 17 are coincident with each other. The distance between the cylindrical lens 16 and the output mirror 11 is equal to the focal distance of the cylindrical lens 16. In addition, the distance between the cylindrical lens 17 and the output mirror 11 is equal to the focal distance of the cylindrical lens 17. The reflection mirror 15 gives a phase variation distribution, the winding number of which is −2k, to the reflected light.

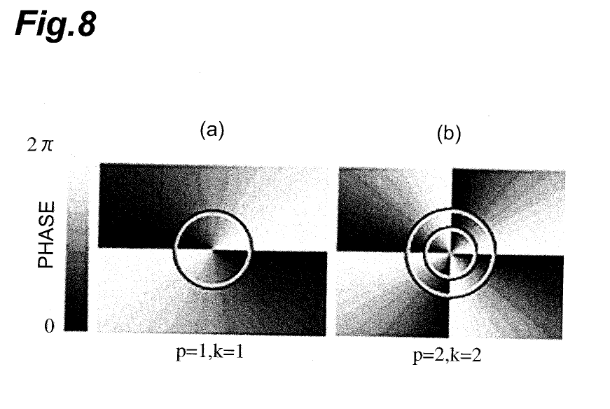

FIG. 8 is a diagram showing examples of the phase variation distribution presented in the reflection mirror 15 included in the laser light source 2 according to the second embodiment. (a) and (b) in FIG. 8, respectively, show the magnitude (0 to 2π) of the phase variation at respective positions on the reflection surface of the reflection mirror 15, using a contrasting density. FIG. 8(a) shows the phase variation distribution to cause the LG(1,1) mode light to be subjected to laser oscillation, wherein a predetermined region including one circumference is made into a loss region, and a phase variation distribution, having a spiral structure in which the winding number is −2, is used in two reflection regions sectioned by the loss region. Further, FIG. 8(b) shows the phase variation distribution to cause the LG(2,2) mode light to be subjected to laser oscillation, wherein predetermined regions respectively including two circumferences are made into loss regions, and a phase variation distribution, having a spiral structure in which the winding number is −4, is used in three reflection regions sectioned by the two loss regions.

In the laser light source 2 which outputs LG(p,k) mode light as the laser oscillation light 31, the phase variation distribution, which is presented in the reflection mirror 15, is generally expressed as follows. p positive real number roots aₗ to aₚ of the Sonine polynomial Sₚ^{k}(z) of the p-order polynomial shown by the following equation (1) are obtained, and the radii r₁ to rₚ of the circumferences at the loss regions are obtained in accordance with the following equation (2) based on these real number roots aₗ to aₚ and the light beam waist radius w. Regions having a certain width, which include the circumferences of respective radii rᵢ (i=1 to p), are made into the loss regions, and the phase variation distribution in the radial direction at the respective loss regions is made into the distribution as shown in FIG. 3 or FIG. 4. In addition, in the (p+1) reflection regions sectioned by the p loss regions, respectively, the phase variation ø(r, θ) is expressed by the following equation (3). r and θ are a radial variable and an angular variable in the polar coordinate system set on the reflection surface of the reflection mirror 15.

$$\begin{matrix}[ Equation 1 ] & \\ {S}_{p}^{k} ( z ) = {\sum }_{j = 0}^{p} \frac{{( - 1 )}^{j} \cdot ( p + \vert k \vert ) !}{( p - j ) ! \cdot ( \vert k \vert + j ) ! \cdot j !} \cdot {z}^{j} & ( 1 ) \\ [ Equation 2 ] & \\ {r}_{i} = w \sqrt{\frac{{a}_{i}}{2}} ( i = 1 , 2 , … , p ) & ( 2 ) \\ [ Equation 3 ] & \\ φ ( r , θ ) = - 2 k θ & ( 3 )\end{matrix}$$

Here, when n is an integer number, an arbitrary phase a and a phase (a+2nπ) are equivalent to each other, and the phase variation distribution may be based on only the relative value with the offset value disregarded. Taking these into consideration, in the phase variation distribution presented at the reflection mirror 15, it is possible to restrict the phase variation to the range from phase a to phase (a+22π), and further, the value of a may be zero.

Further, in the present embodiment, as in the phase variation distribution shown in FIG. 5, the phase variation distribution in which the phase difference between the inside of the circumference of the respective radius rᵢ and the outside thereof becomes 2π may be presented in the reflection mirror 15.

The laser light source 2 according to the second embodiment carries out actions almost similar to those of the laser light source 1 according to the first embodiment, and can bring about similar effects. However, the laser light source 2 according to the second embodiment operates as described below, with respect to the configuration in which the phase variation distribution in which the winding number is −2k as shown in the equation (3) described above is presented in the reflection mirror 15, and the cylindrical lenses 16 and 17 are provided.

That is, if the light incident on the reflection mirror 15 is LG(p,k) mode light, the traveling direction of the light reflected by the reflection mirror 15 is reversed, and at the same time, the phase variation is given in accordance with the above-described phase variation distribution, and thus the LG(p,k) mode is maintained. Also, if the light incident on the output mirror 11 is LG(p,k) mode light, the light is condensed on the reflection surface of the output mirror 11 by the cylindrical lens 17 when it enters, and is collimated by the cylindrical lens 17 after having been reflected by the output mirror 11, and the traveling direction of the reflected light after having been collimated is reversed, and the phase distribution is line-symmetrically converted, and thus the LG(p,k) mode is also maintained. Thus, the LG(p,k) mode light is caused to be subjected to laser oscillation. The laser oscillation light 31 output from the output mirror 11 to the outside is collimated by the cylindrical lens 16.

Further, in the second embodiment, it is preferable that, in addition to the amplitude or phase variation distribution for determining the transverse mode of the laser oscillation light 31, the reflection mirror 15 overlaps and presents the phase variation distribution, which compensates for the phase distortion resulting from optical elements (laser medium 12, light beam diameter adjuster 13, and cylindrical lens 17) in the laser resonator, and it is also preferable that the reflection mirror overlaps and presents the phase variation distribution which operates as a concave mirror, and further, it is also preferable that, in the case where the reflection surface of the reflection mirror 15 is inclined with respect to the plane perpendicular to the optical axis of the laser resonator, the reflection mirror overlaps and presents the phase variation distribution to compensate for the inclination. In such cases, since the reflection mirror 15 is driven by the drive unit 21 controlled by the control unit 22 and the phase variation distribution is presented in the reflection mirror, it is possible to efficiently obtain the laser oscillation light 31 of a specified transverse mode.

In addition, in the second embodiment, in order to efficiently obtain laser oscillation light 31 of a specified transverse mode, it is possible to feedback control the amplitude or phase variation distribution, which is presented in the reflection mirror 15, via the drive unit 21 by the control unit 22 based on the light intensity profile obtained by monitoring the light intensity profile of the laser oscillation light 31.

Although the laser light source 2 according to the second embodiment has a favorable configuration for outputting the LG mode light, the angular index k of which is not zero, as the laser oscillation light 31, it is possible to output the LG mode light, the angular index k of which is zero, as the laser oscillation light 31, and it is also possible to output the HG mode light as the laser oscillation light 31.

Here, the laser light source according to the above—described embodiments is provided with a laser resonator in which the reflection mirror and the output mirror are disposed so as to be opposed to each other with the laser medium placed therebetween. Further, the reflection mirror is configured such that it gives amplitude or phase variations responsive to respective positions in the section of a light beam when the light is reflected, and the reflection mirror presents an amplitude or phase variation distribution in accordance with control from the outside, and determines the transverse mode of the laser oscillation light based on the amplitude or phase variation distribution. In the laser light source, by the amplitude or phase variation distribution being presented in the reflection mirror, the transverse mode of the stimulated emission light efficiently generated in the laser resonator of the laser light source is determined, and the laser oscillation light having the transverse mode is output from the output mirror to the outside.

It is preferable that the laser light source having the above—described configuration is further provided with a light beam diameter adjuster which is provided on the resonance light path in the laser resonator and adjusts the beam diameter of light incident on the reflection mirror. In addition, it is preferable that the laser light source is further provided with an aperture which is provided on the resonance light path in the laser resonator and restricts the beam diameter of light incident on the reflection mirror.

In the laser light source having the above-described configuration, it is preferable that the reflection mirror overlaps and presents a phase variation distribution, which compensates for the phase distortion resulting from optical elements in the laser resonator, in addition to the amplitude or phase variation distribution which determines the transverse mode of the laser oscillation light. Further, it is preferable that the reflection mirror overlaps and presents a phase variation distribution, which operates as a concave mirror, in addition to the amplitude or phase variation distribution which determines the transverse mode of the laser oscillation light.

In the laser light source, it is preferable that the reflection mirror presents the amplitude or phase variation distribution to cause the Laguerre-Gauss mode light to be subjected to laser oscillation. Further, it is preferable that the reflection mirror presents the amplitude or phase variation distribution to cause the Hermite-Gauss mode light to be subjected to laser oscillation.

Industrial Applicability

The present invention is applicable as a laser light source capable of easily controlling the transverse mode of laser oscillation light.

Reference Signs List

1, 2—Laser light source, 11—Output mirror, 12—Laser medium, 13—Light beam diameter adjuster, 14—Aperture, 15—Reflection mirror, 16, 17—Cylindrical lens, 21—Drive unit, 22—Control unit, 31—Laser oscillation light.

1. A laser light source comprising a laser resonator in which a reflection mirror and an output mirror are disposed so as to be opposed to each other with a laser medium placed therebetween;
wherein the reflection mirror is configured such that it gives amplitude or phase variations to respective positions in the section of a light beam when the light is reflected, the reflection mirror presents an amplitude or phase variation distribution in accordance with control from the outside, and determines a transverse mode of laser oscillation light based on the amplitude or phase variation distribution.

2. The laser light source according to claim 1, further comprising a light beam diameter adjuster which is provided on the resonance light path in the laser resonator and adjusts the beam diameter of light incident on the reflection mirror.

3. The laser light source according to claim 1, further comprising an aperture which is provided on the resonance light path in the laser resonator and restricts the beam diameter of light incident on the reflection mirror.

4. The laser light source according to claim 1, wherein the reflection mirror overlaps and presents a phase variation distribution, which compensates for the phase distortion resulting from optical elements in the laser resonator, in addition to the amplitude or phase variation distribution which determines the transverse mode of the laser oscillation light.

5. The laser light source according to claim 1, wherein the reflection mirror overlaps and presents a phase variation distribution, which operates as a concave mirror, in addition to the amplitude or phase variation distribution which determines the transverse mode of the laser oscillation light.

6. The laser light source according to claim 1, wherein the reflection mirror presents the amplitude or phase variation distribution to cause the Laguerre-Gauss mode light to be subjected to laser oscillation.

7. The laser light source according to claim 1, wherein the reflection mirror presents the amplitude or phase variation distribution to cause the Hermite-Gauss mode light to be subjected to laser oscillation.
